(19) United States
(12) Patent Application Publication
(10) Pub. No.: US 2018/0030836 A1
(43) Pub. Date: Feb. 1, 2018

(54) SOLID HOLLOW COMPONENT WITH SHEET METAL FOR PRODUCING A CAVITY

(71) Applicant: SIEMENS AKTIENGESELLSCHAFT, MÜNCHEN (DE)

(72) Inventors: Robert Frantzheld, Berlin (DE); Jacek Grodzki, Berlin (DE); Holger Hesse, Hamburg (DE); Susanne Kamenzky, Berlin (DE); Khaled Maiz, Berlin (DE); Dirk Mertens, Berlin (DE); Romina Pipke, Berlin (DE); Eva Scheu, Berlin (DE); Eric Wiemann, Berlin (DE)

(21) Appl. No.: 15/551,456

(22) PCT Filed: Feb. 24, 2016
(86) PCT No.: PCT/EP2016/053811

§ 371 Date: Aug. 16, 2017

(30) Foreign Application Priority Data
Mar. 3, 2015 (DE) 10 2015 203 765.7

(51) Int. Cl. F01D 5/18; F01D 5/14

(52) U.S. Cl. CPC F01D 5/18; F01D 5/147; F05D 2230/21; F05D 2230/25; F05D 2230/232; F05D 2300/10; B22D 27/045

(57) ABSTRACT

A method in which a hollow component is produced by the method steps consisting in casting and joining a sheet metal, wherein the hollow component can include thin walls and has a high recession in geometry is provided.

### CROSS-REFERENCE TO RELATED APPLICATIONS

This application claims priority to PCT Application No. PCT/EP2016/053811, having a filing date of Feb. 24, 2016, based off of German application No. DE 102015203765.7, having a filing date of Mar. 3, 2015, the entire contents of both are hereby incorporated by reference.

### FIELD OF TECHNOLOGY

The following relates to a cast component which is intended to be designed to be hollow, wherein a cavity is produced only by joining a metal sheet.

### BACKGROUND

Currently, the length of the turbine blade of the rear row limits the power of large gas turbines due to the combination of high centrifugal forces and high temperatures, and thus the current solution of solid, cast blades meets its limits. However, it is necessary to lengthen these blades, in combination with hollowing-out for cooling purposes, in particular for the coming developments in order to make the required power increases possible. However, increasing the size of the blade would also lead to an increase in weight, which would result in the centrifugal forces being greater than the blade can withstand. It is therefore necessary to reduce the weight of the blade.

### SUMMARY

An aspect relates to specifying a component and a method with which above-mentioned problems can be solved.

Since the production of large, hollow, thin-walled components is not possible by casting, only the blade root—including the leading and trailing edges of the blade—is cast. In so doing, the leading and trailing edges can at least preferably be made hollow and cooled accordingly. The blade airfoil is closed using a thin metal sheet which is respectively attached, on the pressure and suction sides, to the leading and trailing edges by means of perpendicular weld seams (non-critical since parallel to the direction of the centrifugal forces). For further weight reduction, it would be possible to optimize the material of the metal sheets and also to provide the metal sheets with a coating for protection from the high temperatures and oxidation.

The blade airfoil is not cast in its entirety, but rather is constructed of multiple constituent parts, the suction and pressure sides of the blade airfoil being replaced with simply, curved metal sheets that are thin and lightweight. In order to stabilize the airfoil, it is possible for cross braces to be introduced into the interior of the blade, between the leading and trailing edges.

Since the production of thin walls is not possible by casting, only the blade root—including part of the blade airfoil, that is to say the leading and trailing edges and preferably one side of the blade airfoil—is cast. Whether one casts the pressure side or the suction side can be decided on the basis of the complexity of the shape. Preferably, one would cast the more complex side and replace the simpler side with a metal sheet. The fact that the cast blade is then open makes it far simpler to measure the wall thickness, and also facilitates mechanical machining for thinning. The blade airfoil is closed with a thin metal sheet, using weld seams. Since the inherent weight of the metal sheet is low, it can be assumed that the strength of the weld seams will be adequate. For further weight reduction, it would be possible to optimize the material of the metal sheet and also to provide the metal sheet with a coating for protection from the high temperatures and oxidation.

The blade airfoil is cast open and not in its entirety, but rather is constructed of two constituent parts, markedly simplifying both mechanical machining of the blade airfoil from the inside and also measurement of the wall thickness. The suction or pressure side of the blade airfoil is replaced with a simply, curved metal sheet that is thin and lightweight. In order to stabilize the airfoil, it is possible for a type of scaffold to be introduced into the interior of the blade, between the leading and trailing edges.

### BRIEF DESCRIPTION

Some of the embodiments will be described in detail, with reference to the following figures, wherein like designations denote like members, wherein:

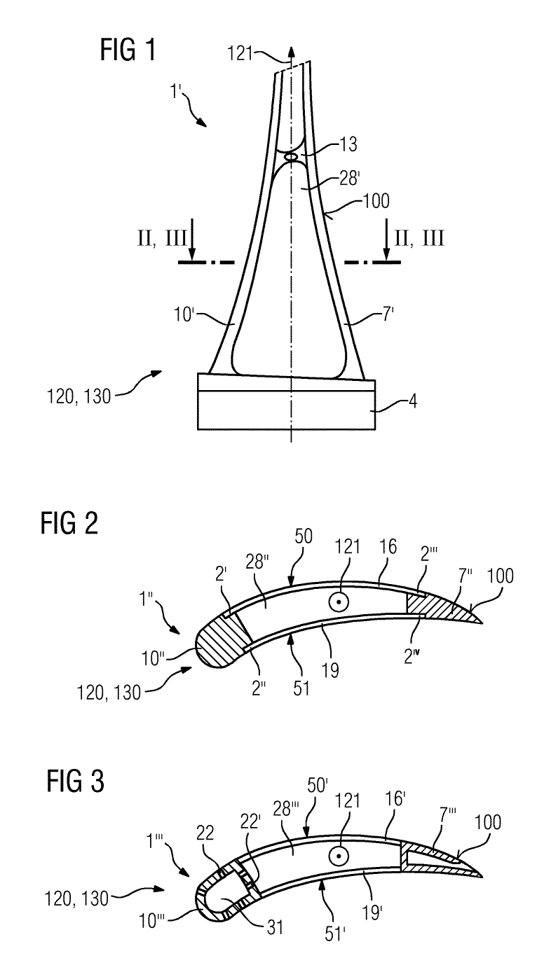

FIG. 1 shows a first view of hollow components to which no metal sheet has yet been joined, in accordance with embodiments of the present invention;

FIG. 2 shows a first cross section through a hollow component, to which at least one metal sheet has been joined, in accordance with embodiments of the present invention;

FIG. 3 shows a second cross section through a hollow component, to which at least one metal sheet has been joined, in accordance with embodiments of the present invention;

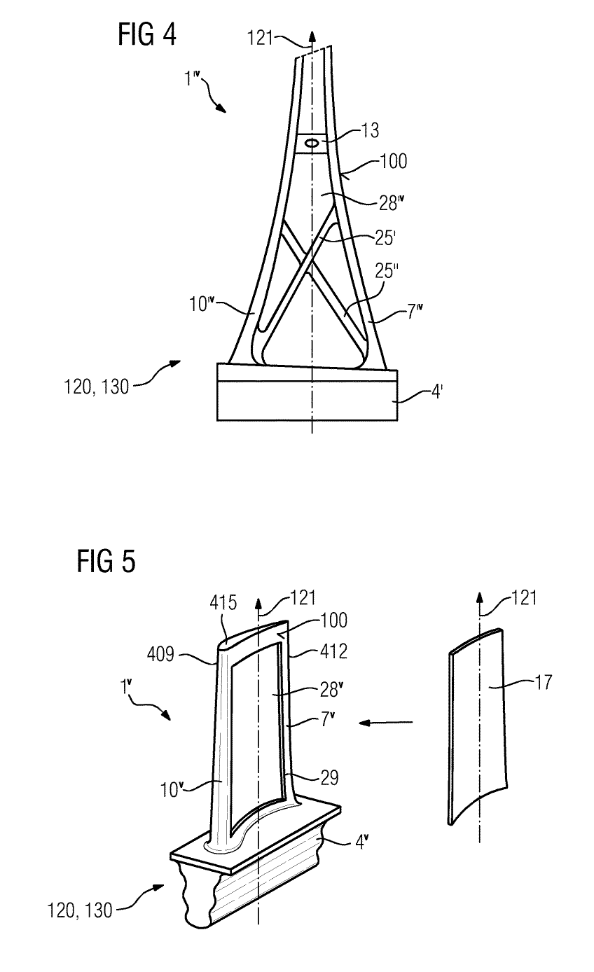

FIG. 4 shows a second view of hollow components to which no metal sheet has yet been joined, in accordance with embodiments of the present invention;

FIG. 5 shows the overview of a scaffold of a hollow component that is to be produced, for example explained with reference to a turbine blade, in accordance with embodiments of the present invention; and

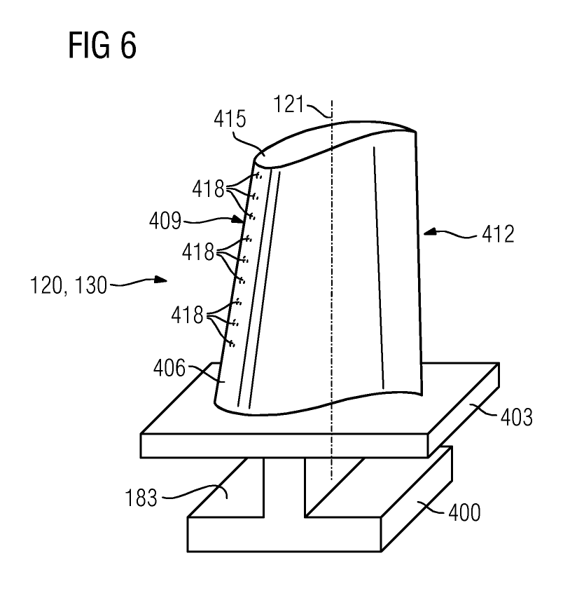

FIG. 6 shows a turbine blade, in accordance with embodiments of the present invention.

The figures and the description present only exemplary embodiments of the invention.

### DETAILED DESCRIPTION

FIG. 2 shows, in cross section, a first exemplary embodiment of the invention, in which a cast scaffold 1″ has preferably two cutouts 50, 51, and preferably a front element 10″ (leading edge 409, FIG. 6) and a rear element 7″ (trailing edge 412, FIG. 6) are present as a cast element, which preferably extend along a longitudinal axis 121 of a component 120, 130 (FIG. 6).

The front element 10″ and the rear element 7″ form part of the outer surface 100 of the component 120, 130 and are cast together with the scaffold 1″.

An attachment region 4 (FIG. 1), preferably having no metal sheets, is also cast therewith, the front element 10″ and the rear element 7″ adjoining this region.

The attachment region 4 is present at one end of the component 120, 130.

Between the front element 10″ and the rear element 7″ there are on both sides preferably respective cutouts 50, 51.

The cutouts 50, 51 extend in the direction of the longitudinal axis 121 over the length of the front element 10″ and the rear element 7″.

Since the cutouts 50, 51; 50′, 51′ (FIG. 3) are present on opposite sides, the joining of two metal sheets 16, 19; 16′, 19′ (FIG. 3) into the cutouts 50, 51; 50′, 51′ creates a cavity 28″, 28′″ between the suction side and pressure side of the component 120, 130.

At the rear element 7″ and the front element 10″, the metal sheets 16, 19; 16′, 19′; 17 (FIG. 5) bear against more recessed surfaces 2′, . . . , 2^{IV}, such that their outer surface ends flush with the surface 100 of the front element 10″ and the rear element 7″ in the region of their transition.

The front element 10″ and the rear element 7″ and the metal sheets 16, 19; 16′, 19′; 17 are preferably elongate and narrow.

The metal sheets 16, 19; 16′, 19′; 17 represent the side surfaces of the hollow component 120, 130, the greatest portion being made up thereby.

The metal sheets 16, 19; 16′, 19′; 17 can be made in various ways.

The metal sheets 16, 19; 16′, 19′; 17 are preferably welded to the scaffold 1′, 1″, 1′″, 1^{IV}, 1^{V}, with the weld seams, in particular all weld seams, running parallel to the load direction, in this case the longitudinal axis 121 of the component 120, 130.

If the turbine blade 120, 130 requires cooling, the front element 10′″ and the rear element 7′″ can be designed as hollow elements (FIG. 3), at least one outlet 22′ being present between at least the front cavity 31 of the front element 10′″ and the cavity 28′″, in order to permit the exchange of coolant.

The outlets 22, 22′ preferably represent passages to the cavities 28′″ and/or to the surface 100.

The cavity 28′, . . . , 28^{IV} can also be supplied via the blade root 4, 4′, 4^{V}.

For the sake of stability, preferably one connection 13 (FIG. 1) is present between the front elements 10′ and the rear elements 7′, which connection ensures the separation between the front element 10′ and the rear element 7′ (FIG. 1).

The connection is present in the upper half. The half relates to the length of the metal sheets along the longitudinal axis 121.

In the lower region there are preferably, and very particularly in addition to the connection in the upper half, one or more cross braces 25′, 25″ for stability (FIG. 4).

The turbine blade 120, 130 in FIG. 5, as an exemplary hollow component 120, 130, has a solid blade root 4^{V}, adjoining which is a blade airfoil that is internally hollow.

The cavities 28′, . . . , 28^{V} can be used for internal cooling. The metal sheets 16, 19; 16′, 19′; 17 preferably have, on the inner surfaces, certain structures such as cooling channels or other elevations.

The metal sheet 17 or the metal sheets 16, 19; 16′, 19′ can also have, on their inner side, structures or elevations to form internal cooling channels.

This is also the case for the metal sheets 16, 19; 16′, 19′ of FIGS. 2, 3.

The scaffold 1^{V} (FIG. 5) is cast, but a front element 10^{V} and a rear element 7^{V} are present as seen in the longitudinal direction, these having a cutout 29 into which a metal sheet 17 can be joined.

This production process according to the figures does not produce a hollow cast component, and does away with the use of cores or other problems. A cutout 29 is closed using a metal sheet which may also have been cast or can also be produced otherwise, thus creating a hollow component.

The scaffold 1′, . . . , 1^{V} can also be a forged part.

FIG. 6 shows, in perspective, a rotor blade 120 or guide blade 130 of a turbomachine, which extends along a longitudinal axis 121.

The turbomachine can be a gas turbine of an aircraft or of a power plant for electricity generation, a steam turbine or a compressor.

The blade 120, 130 has, in succession along the longitudinal axis 121, an attachment region 400, adjoining this a blade platform 403 and a blade airfoil 406 and a blade tip 415. As a guide blade 130, the blade 130 can have another platform at its blade tip 415 (not shown).

A blade root 183 is formed in the attachment region 400 and serves to attach the rotor blades 120, 130 to a shaft or a disk (not shown).

The blade root 183 is for example designed as a hammerhead. Other configurations, as a fir tree root or a dovetail root, are possible.

The blade 120, 130 has, for a medium flowing past the blade airfoil 406, a leading edge 409 and a trailing edge 412.

In conventional blades 120, 130, in all regions 400, 403, 406 of the blade 120, 130, use is made for example of solid metallic materials, in particular superalloys.

Superalloys of this kind are known for example from EP 1 204 776 B1, EP 1 306 454, EP 1 319 729 A1, WO 99/67435 or WO 00/44949.

In that context, the blade 120, 130 can be made of this material by means of a casting method, also by means of directional solidification, by means of a forging method, by means of a milling method or combinations thereof.

Workpieces with single-crystal structure or structures are used as components for machines which, during operation, experience high mechanical, thermal and/or chemical loads.

Such single-crystal workpieces are produced for example by directional solidification from the melt. This is a casting method in which the liquid metal alloy solidifies to the single-crystal structure, that is to say to the single-crystal workpiece, or directionally.

In that process, dendritic crystals are oriented along the heat flow and form either a columnar crystalline grain structure (columnar means grains that extend over the entire length of the workpiece, this being referred to here, in accordance with general parlance, as directionally solidified) or a single crystal structure, that is to say the entire workpiece consists of a single-crystal. In these methods, it is necessary to avoid the transition to globular (polycrystalline) solidification, since non-directional growth necessarily results in transverse and longitudinal grain boundaries which negate the desirable properties of the directionally solidified or single-crystal component.

In general parlance, directionally solidified structures include both single crystals, which have no grain boundaries or at most small-angle grain boundaries, and columnar crystal structures which do have grain boundaries running in the longitudinal direction but no transverse grain boundaries. These second crystalline structures are also referred to as directionally solidified structures.

Such methods are known from U.S. Pat. No. 6,024,792 and EP 0 892 090 A1.

The blades 120, 130 can also have coatings to protect against corrosion or oxidation, for example (MCrAlX; M is at least one element from the group iron (Fe), cobalt (Co), nickel (Ni), X is an active element and represents yttrium (Y) and/or silicon and/or at least one element of the rare earths, or hafnium (Hf)). Alloys of this kind are known from EP 0 486 489 B1, EP 0 786 017 B1, EP 0 412397 B1 or EP 1 306 454 A1.

The density is preferably 95% of the theoretical density.

On the MCrAlX layer (as intermediate layer or as outermost layer) there forms a protective aluminum oxide layer (TGO=thermally grown oxide layer).

Preferably, the layer composition has Co-30Ni-28Cr-8Al-0.6Y-0.7Si or Co-28Ni-24Cr-10Al-0.6Y. In addition to these cobalt-based protective coatings, use is also preferably made of nickel-based protective layers such as Ni-10Cr-12Al-0.6Y-3Re or Ni-12Co-21Cr-11Al-0.4Y-2Re or Ni-25Co-17Cr-10Al-0.4Y-1.5Re.

On the MCrAlX there can also be a thermal barrier layer which is preferably the outermost layer and consists for example of ZrO₂, Y₂O₃—ZrO₂, that is to say that it is unstabilized, partially stabilized or fully stabilized by yttrium oxide and/or calcium oxide and/or magnesium oxide.

The thermal barrier layer covers the entire MCrAlX layer.

Using suitable coating methods such as electron beam physical vapor deposition (EB-PVD) creates columnar grains in the thermal barrier layer.

Other coating methods are conceivable, for example atmospheric plasma spraying (APS), LPPS, VPS or CVD. For better thermal shock resistance, the thermal barrier layer can have grains that are porous or have microscopic or macroscopic cracks. Thus, the thermal barrier layer is preferably more porous than the MCrAlX layer.

Refurbishment means that, after use, components 120, 130 may have to have protective layers removed (for example by sandblasting). This is followed by removal of the corrosion and/or oxidation layers or products. Any cracks in the component 120, 130 are also repaired. This is followed by re-coating of the component 120, 130 and re-use of the component 120, 130.

The blade 120, 130 can be hollow or solid. If the blade 120, 130 requires cooling, it is hollow and may also have film-cooling holes 418 (shown as dashes).

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A hollow component which is at least partially and at most partially cast or forged, wherein a cast or forged element of the hollow component represents a scaffold for at least one metal sheet that is to be inserted, wherein the at least one metal sheet is joined to the scaffold, wherein, in a joined state, the at least one metal sheet forms a cavity with the scaffold and represents an inner surface of a cavity of the hollow component, and wherein the at least one metal sheet also forms an outer surface of the hollow component.

2. The hollow component as claimed in claim 1, wherein only one metal sheet is present, which bounds the cavity.

3. The hollow component as claimed in claim 1, wherein two metal sheets are present, which bound the cavity.

4. The hollow component as claimed in claim 1,wherein the scaffold has at least one cutout for the at least one metal sheet.

5. The hollow component as claimed in claim 3, wherein the two metal sheets are arranged opposite one another.

6. The hollow component as claimed in claim 1, wherein, at least in a part region, is of elongate and narrow design with an aspect ratio >3, wherein the part region is formed by the scaffold.

7. The hollow component as claimed in claim 1, wherein the scaffold has a front element as a leading edge and a rear element as a trailing edge, wherein the front element and the rear element represent part of the outer surface of the hollow component, and are cast or forged.

8. The hollow component as claimed in claim 7, which extends along a longitudinal axis and in which, as seen along the longitudinal axis, there is a connection in an upper half between the front element and the rear element of the scaffold, transverse to the longitudinal axis.

9. The hollow component as claimed in claim 1, which extends along a longitudinal axis and in which, as seen along the longitudinal axis, in a lower part of the scaffold, there are at least one cross brace between a front element and a rear element.

10. The hollow component as claimed in claim 1, wherein a greatest part of the weight, at least 85% of the hollow component is cast or forged and the cavity is formed by welding the at least one metal sheet.

11. The hollow component as claimed in claim 1, wherein at least a front element is hollow, and has openings to the cavity formed by the metal sheets.

12. The hollow component as claimed in claim 1, wherein all weld seams between the at least one metal sheet and the scaffold run parallel to the longitudinal direction.

13. The hollow component as claimed in claim 1, further comprising a solid part with no metal sheets, which is present only at one end of the hollow component.

14. The hollow component as claimed in claim 1, wherein at least a front element is hollow, and has openings to a surface.

15. A method for producing a component as claimed in claim 1, wherein a greatest part of the weight of the hollow component is cast or forged and a cavity is formed by welding the at least one metal sheet.

16. The hollow component as claimed in claim 1, wherein a greatest part of the weight, at least 75% of the hollow component is cast or forged and the cavity is formed by welding the at least one metal sheet.
